(19) United States
(12) Patent Application Publication
(10) Pub. No.: US 2013/0038450 A1
(43) Pub. Date: Feb. 14, 2013

(54) Automatically Generating Electronic Notifications in Response to Received Mail

(71) Applicant: Brett B. Stewart, Austin, TX (US)

(72) Inventor: Brett B. Stewart, Austin, TX (US)

(21) Appl. No.: 13/205,697

(22) Filed: Aug. 9, 2011

(51) Int. Cl. G08B 13/14

(52) U.S. Cl. 340/569

(57) ABSTRACT

System and Method for mail notification. An apparatus includes a first member adapted to be placed on an interior portion of the post office box, a flap member rotatably attached to the first member, and a sensor included in at least one of the first member or the flap member. When the apparatus is placed inside the post office box, and when the flap member is moved to be proximate to the first member to allow placement of content inside the post office box, the sensor detects proximity of the flap member to the first member or movement of the flap member from a first position to a second position, and provides an indication in response to detection of proximity, wherein the indication is useable to notify a recipient associated with the post office box.

### BACKGROUND OF THE INVENTION

1. Field of the Invention

This invention relates to notifying a recipient of received mail or other content, and more particularly, to automatically generating electronic notifications in response to received mail/content.

2. Description of the Relevant Art

In typical prior art post office (PO) box systems, mail items are deposited in each PO box from the rear, and extracted from the front of the PO box by the associated user. There is currently no way for the users to know when (or to be automatically notified when) they have mail to be retrieved, and so each user must periodically (sometimes several times per day) check the PO box for contents, which is time-consuming and inefficient.

### SUMMARY OF THE INVENTION

Systems and methods for automatically generating electronic notifications in response to received content, such as received mail. Each of a plurality of PO boxes may be configured with a respective apparatus. Each apparatus respectively includes a first member adapted to be placed on an interior portion of the respective post office box, a flap member rotatably attached to the first member, and a sensor comprised in at least one of the first member or the flap member. The apparatus is configured to be installed inside the respective post office box. When so installed, when the flap member is moved to be proximate to the first member to allow placement of content inside the respective post office box, the sensor may be configured to detect proximity of the flap member to the first member (or movement of the flap member), and provide an indication in response to detection of proximity. The indication is useable to notify a recipient associated with the respective post office box.

A controller may be wirelessly coupled to each of the apparatuses. The controller may be coupled to a network, e.g., a local area network (LAN), or a wide area network (WAN), such as the Internet, thereby providing communicative access to a plurality of client systems, each associated with a respective PO box. The controller may be configured to receive the indication from the sensor of a respective apparatus of the plurality of apparatuses, and send a notification of the content over the network to the recipient associated with the respective post office box in which the respective apparatus is installed. The notification may be of any type desired, including, for example, one or more of an email message, an instant messaging (IM) message, a cellular telephone text message, or a social networking site message, among others. Similarly, the client systems may each be of any type desired.

In some embodiments, the flap member may maintain a first position when there is no content in the PO box, and may maintain a second position (i.e., a position different from the first position) when there is content in the PO box. For example, a letter or other content may be placed inside the PO box to hold the flap member in an upright position. Thus, when the apparatus is placed or installed inside the PO box, and when the flap member changes position to allow placement of content inside the post office box, the sensor is configured to detect the change in position of the flap member, and provide an indication in response to the detected change in position. The indication is useable to notify a recipient associated with the post office box. In an alternative embodiment, where the content, e.g., a letter, is not kept upright to hold the flap member up (in the second position), the sensor may be configured to detect movement rather than position, and so may generate an indication anytime the flap member is moved, e.g., any time mail (or other content) is inserted (or removed) from the rear (employee side) of the PO box.

Thus, in one embodiment, content may be placed in a post office box configured with an apparatus as described herein. The sensor may detect proximity of the flap member to the first member (and/or a change in position of the flap member with respect to the first member). The detection may be with respect to a change in position (including orientation) of the flap member, e.g., from the first position to the second position, and may be via any of various types of sensor.

The sensor may provide an indication in response to detection of proximity, where the indication is useable to notify a recipient associated with the post office box, as described above. Thus, for example, in one exemplary embodiment, the sensor may send the indication to the controller via wireless means, where the indication possibly includes the type of mail. In some passive embodiments, the indication provision (and possibly the detection) may be performed in response to a chirp signal from the controller. Thus, the controller may periodically (or even randomly) query the PO boxes (e.g., the sensors) to retrieve or invoke transmission of the indications. In contrast, in some active embodiments, the sensors may send the indication to the controller when content is first inserted into the PO box, or periodically (or randomly). The controller may then generate a notification based on the indication, and send the notification to the recipient associated with the PO box.

Thus, various embodiments of the above systems and methods may provide for automatic detection and notification of content in PO boxes.

### BRIEF DESCRIPTION OF THE DRAWINGS

Advantages of the present invention will become apparent to those skilled in the art with the benefit of the following detailed description and upon reference to the accompanying drawings in which:

FIG. 1 is an illustration of a prior art post office (PO) box system, according to one embodiment;

FIG. 2 is an illustration of an exemplary apparatus for detecting content in a PO box, according to one embodiment;

FIG. 3A is an illustration of an exemplary PO box configured with an exemplary sensor, where the PO box has no contents, according to one embodiment;

FIG. 3B is an illustration of the PO box of FIG. 3A, but where the PO box has contents, according to one embodiment;

FIG. 4 is an illustration of a PO box system with multiple PO boxes and a controller, according to one embodiment;

FIG. 5 is an exemplary block diagram of a controller, according to one embodiment; and

FIG. 6 is a flowchart that illustrates a method of automatically generating electronic notifications in response to received mail, according to one embodiment.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known structures and techniques have not been shown in detail to avoid obscuring the present invention.

FIG. 1 illustrates an exemplary PO box system, according to the prior art. As may be seen, this exemplary system includes a plurality of PO boxes, each accessible from the rear (e.g., by an employee) and from the front (e.g., by a user). As noted above, there is currently no way for a user to know when (or to be automatically notified when) content has been inserted into his or her PO box, and so each user typically must travel to the post office and manually check for content.

As used herein, the term “automatic” (or “automatically”) refers to action being performed without direct manual user input required to perform the action. For example, the “automatic notification” described herein refers to notification that a user has mail without requiring manual action from post office personnel to notify the user. In other words, post office personnel are not required to manually check a PO box and/or manually notify the user by making a phone call or typing an email.

Note that as used herein, the term “post office” refers to any place where multiple PO (mail) boxes are situated and serve multiple users. Thus, a post office may be an official government Post Office, or a mail delivery office or room owned and/or operated by a business or organization, such as a company's internal mail room, or a private (or publically owned) mail/package delivery site that services multiple users, such as those operated by Pak Mail, Mail Boxes, Etc., and so forth. Similarly, as used herein, “PO box” refers to any mailbox in such a facility where, as noted above, the mailbox is used to hold mail for a user. In some embodiments he mailbox may be accessible from the rear by an employee and from the front by a user.

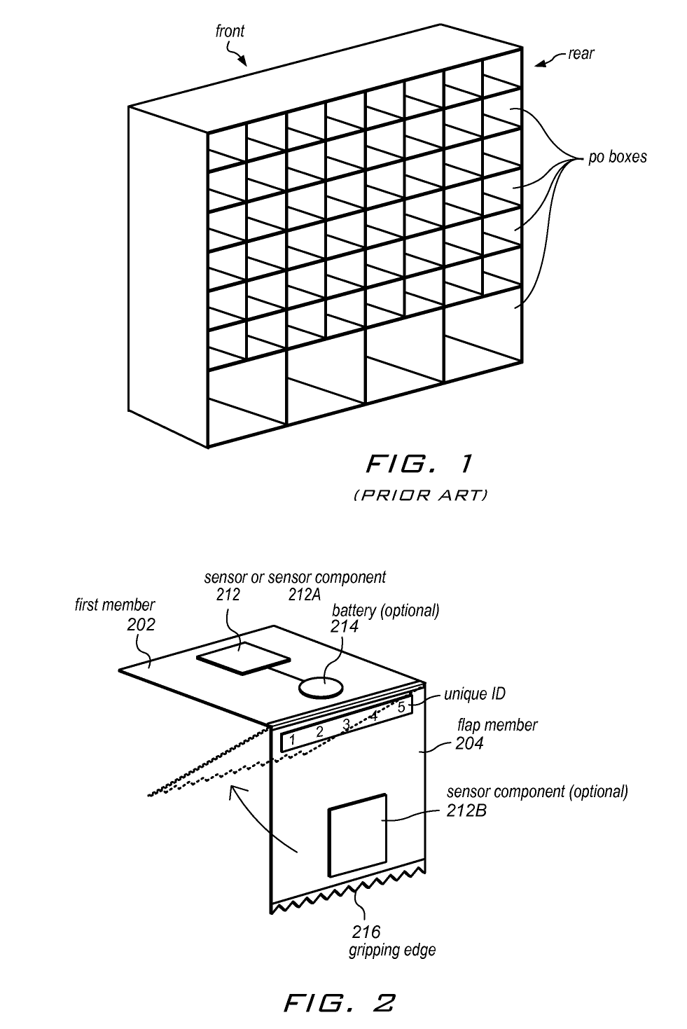

FIG. 2 is an illustration of an exemplary apparatus for detecting content in a PO box, according to one embodiment. As FIG. 2 shows, in this embodiment, the apparatus includes a first member 202 adapted to be placed on an interior portion of a post office box, and a flap member 204 rotatably attached to the first member 202. Note that the rotatable attachment may be implemented by a simple hinge joining two separate and distinct (first and flap) members, or may simply be a fold (possibly scored) in a single piece of material that includes both members. However, any type of hinging mechanism may be used as desired.

A sensor 212 may be included in at least one of the first member or the flap member. For example, the sensor 212 may be included in the first member, the flap member, or distributed between the first member and the flap member, as shown in FIG. 2A, where a first sensor component 212A is included in the first member 202, and a second sensor component 212B is included in the flap member 204. Note further that in various embodiments, the sensor may include one or more active and/or passive elements or components, and may utilize any sensor technologies as desired, as will be described below in more detail.

The sensor 212 may be configured such that, when the apparatus is placed, e.g., installed, inside the post office box, and when the flap member is moved to be proximate to the first member to allow placement of content inside the post office box, the sensor detects proximity of the flap member to the first member. The sensor may then provide an indication in response to detection of proximity, where the indication is useable to notify a recipient associated with the post office box.

In one embodiment, as illustrated in FIG. 2, when there is no content in the PO box, the flap member may maintain a first position (including orientation), e.g., in which the flap member hangs vertically from the top of the PO box; and when there is content in the PO box, the flap member may maintain a second position (e.g., orientation), e.g., in which the flap member is displaced from the first position (e.g., orientation) by the content. To detect change in position of the flap member proximate to the first member, the sensor may be configured to distinguish between the first and second positions, thereby detecting whether or not the post office box has content, and to provide the indication in response to detection of the flap member in the second position. Thus, the sensor may detect a change in position (including a change in orientation) of the flap member resulting from insertion of contents into the PO box. Note that in some embodiments, while the first position may be quantified, e.g., substantially vertical, the second position may simply be any position that is substantially different from the first position.

In one embodiment, when installed in a PO box, the first member may be removeably attached to the interior surface of the PO box. For example, the first member may be affixed to the top inner surface of the PO box by an adhesive that allows for subsequent detachment of the first member, e.g., for replacement, or to move the apparatus to another PO box. In other embodiments, any other means of removeable attachment may be used as desired. In some embodiments, the first member and/or the flap member may be trimmed to fit the PO box into which it is installed.

As noted above, in some embodiments, the sensor may be a passive sensor, i.e., may not include or require an active power source. For example, the sensor may utilize the Hall effect or electromagnetic induction to determine when the flap member is move from the first position. Thus, for example, in one embodiment, the first member (or alternatively, the flap member) may include a Hall or inductive sensor, and the flap member (or alternatively, the first member) may include a magnet, where the movement of the flap member, and thus, the magnet, (from the first position) induces a change in voltage or current in the Hall (effect) or inductive sensor, thereby indicating that content has been put in the PO box.

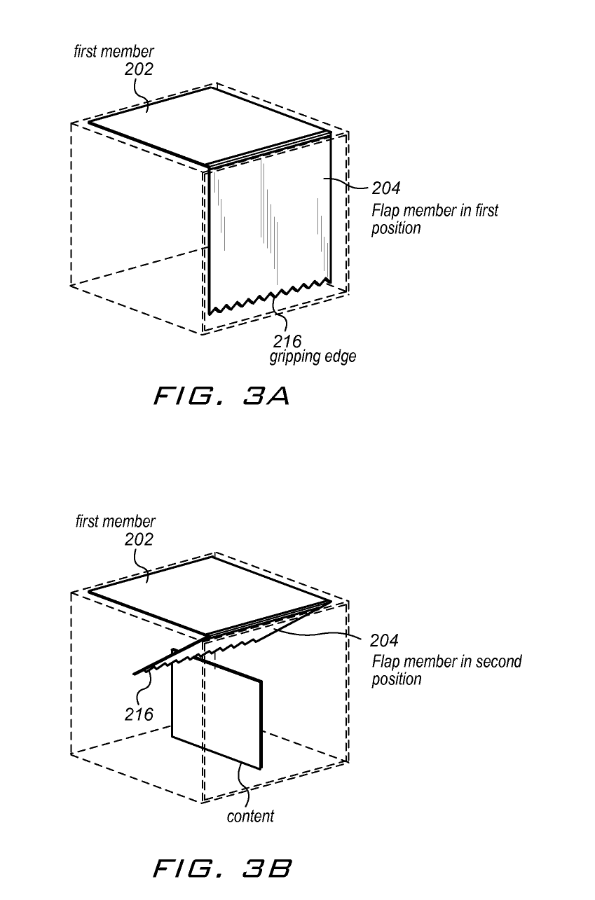

FIGS. 3A and 3B illustrate an exemplary PO box configured with a sensor, according to one embodiment. More specifically, FIG. 3A shows a configured PO box with no contents, and FIG. 3B shows the same configured PO box with contents.

As FIG. 3A shows, in this embodiment, the flap member hangs vertically, maintaining the first position because there are no contents in the PO box to displace the flap member from this position. In contrast, as FIG. 3B shows, in this embodiment, mail has been inserted in the PO box, thereby moving the flap member from the first position, and thus to the second position. Note that in some embodiments, the flap member may include a bottom edge configured to hold the content in place when the flap member is in the second position. For example, as shown in FIGS. 2, 3A and 3B, the flap member may be configured with a rough or jagged edge that may operate to hold letters or other content in a substantially vertical position, thus preventing the letters (or other content) from falling over sideways in the PO box, as illustrated in FIG. 3B. In a further embodiment, a rough surface may be provided in the bottom of the PO box to prevent similar slipping of the bottom edge of the letters (or other content). Note that any type of rough edge or material may be used as desired, including any type of edge trim pattern, e.g., zig-zag, cycloid, etc., or fuzzy material, such as Velcro™, velvet, corduroy, etc. Additionally, the flap member may be weighted.

Referring again to FIG. 2, in one embodiment, the apparatus may also include an identifier (ID) that uniquely identifies the apparatus. The ID may include a human readable representation of the ID, as shown, and a machine readable representation of the ID. Said another way, the ID may be readable by a human, e.g., printed on the flap member, and may also be encoded in such a way that a machine or machine component may read or query the ID. For example, the ID may be encoded in a radio frequency ID (RFID) tag that may be queried by a controller, e.g., via a chirp signal that invokes transmission (or passive emission) of the ID. In other words, the machine readable representation of the ID may include an RFID tag configured to wirelessly transmit the ID to a controller in response to a chirp signal. Of course, any other encoding means may be used as desired, an RFID tag being but one of numerous ways to encode (and retrieve) such information. In one embodiment, the ID may be in the form of a bar code, e.g., on the flap member, and so may be read by any bar code reader, operated by a human, or by machine. The bar code reader may thus be used to map (or remap) the particular apparatus to the PO box, e.g., as part of an initialization routine for each PO box/apparatus.

In another exemplary embodiment, the flap member may include a flat antenna, e.g., printed, sandwiched, etc.), whose response to a chirp signal indicates orientation of the flap member.

In some embodiments, the apparatus may further include a replaceable battery 214, configured to provide power to the apparatus, as illustrated in FIG. 2. For example, the sensor may be an active sensor, and the replaceable battery may be configured to power the active sensor. The sensor may be configured to actively transmit the ID, the indication, or both, to a controller via wireless means. In other words, the sensor may include a transmitter. Of course, the battery may power any other components of the apparatus as needed. For example, the apparatus may include a transmitter (that may be distinct from the sensor), such as a circuit board Zigbee transmitter for light Bluetooth communications. The battery may be coupled to the transmitter and configured to provide power to the transmitter, which may actively transmit the ID, the indication, or both, to a controller via wireless means. Note that with a battery, the system may not require a chirp signal, but instead may transmit information, e.g., broadcast RFID information, as needed.

Note that any of various types of sensors may be used as desired, including for example, one or more of: a tilt sensor, an orientation sensor, a motion sensor, a light sensor, a weight sensor, a Hall effect sensor, an induction sensor, a reed switch, or an electrical contact sensor, among others. More generally, any type of sensor may be used that can be utilized to detect content in the PO box. For example, a tilt switch (e.g., utilizing mercury) may be affixed to the flap member, and may detect a change in orientation. As a further example of a passive sensor system, a conductor, such as a metallic foil, may be attached to the ceiling of the PO box, possibly as part of the first member, and a capacitive sensor in the flap member may detect proximity (or change in position) with respect to the conductor. In a yet further example, a switch may be inserted between bits of an RFID tag in the flap member, where the switch provides an orientation bit value based on the orientation of the flap member, and so the orientation of the flap member may be detected by the code read from the RFID tag.

It should be noted that in various embodiments, the sensor may be considered to include a passive element that the sensor detects. For example, a Hall effect sensor in the first member and a magnet in the flap member (or vice versa) may be considered to be a single distributed sensor for detecting a change in the relative position of the first and flap members.

Note further that other geometric configurations of the apparatus are also contemplated. For example, in one embodiment, the first member may be removeably attached to the floor of the PO box, and the flap member may stand vertically upward from the first member. Insertion of content into the PO box may thus move the flap member down (instead of up, as described above), bringing it (at least more) proximate to the first member.

It should be noted that content may include more than just delivered letters or packages. Note, for example, that some mail items may not fit in the PO box, may require a signature for pickup, or may require or allow special handling. Thus, in some embodiments, the content of the post office box may include at least one proxy card in the post office box. The at least one proxy card may indicate one or more of: mail that has been delivered but is not in the post office box, or mail that is present in the post office box. The proxy card may thus be placed in the PO box in lieu of a mail item, where the proxy card serves to displace the flap member, thus triggering detection of the content and generation of the indication.

Moreover, in one embodiment, the at least one proxy card may indicate type of the mail. For example, there may be a proxy card type of each of various categories of mail, e.g., parcels too big to fit in the PO box, registered mail items, and so forth, as desired. The sensor may be configured to query the proxy card and include the type of mail in the indication. Thus, each proxy card may include (preferably passive) means for encoding a mail type. For example, in one embodiment, the proxy card may include an RFID tag, which may be queried via a chirp signal from the controller, or, alternatively, from the sensor. In another embodiment, the proxy card may be detected in the same manner as the flap member position, e.g., using a magnetic/Hall effect based approach.

For example, the flap member may include two Hall effect sensors, where a first Hall effect sensor detects flap member position, e.g., via a hinge magnet (or other suitably positioned magnet), and a second Hall effect sensor detects the proxy card. For example, detection of an N (North) magnet may mean “too big for PO box”, detection of an S (South) magnet may mean “you have to sign for the mail”, and so forth. Note, however, that in other embodiments, any sensor method or system may be used as desired to implement the proxy cards.

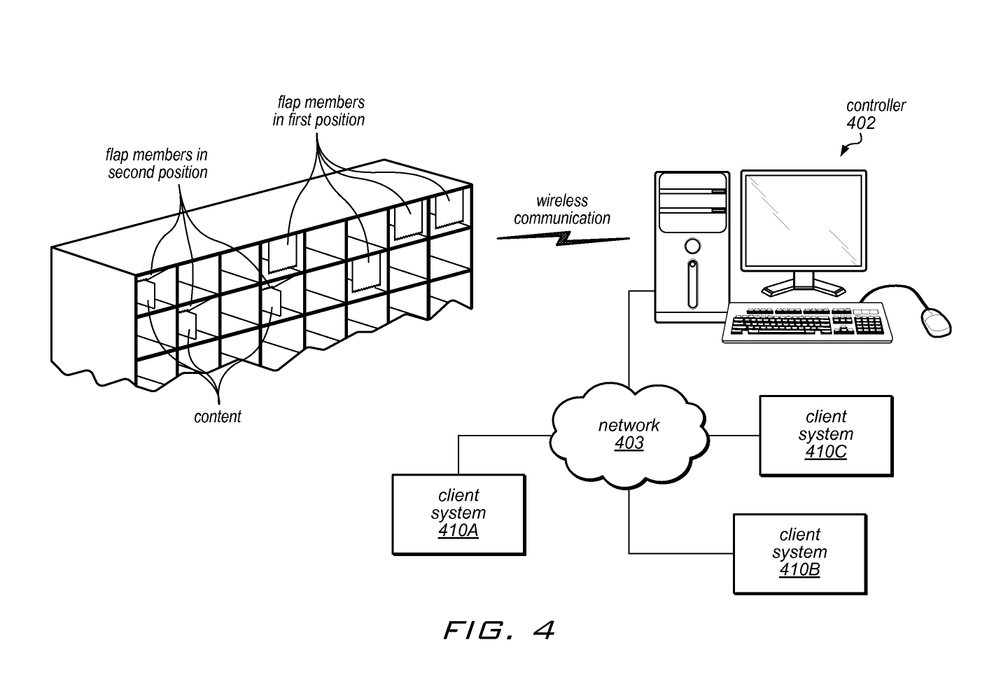

FIG. 4 is an illustration of a PO box system with controller 402, according to one embodiment. As may be seen, each of a plurality of PO boxes may be configured with a respective apparatus. More specifically, the system may include a plurality of apparatuses, each of the apparatuses installed in a respective post office box, and each of the apparatuses respectively including a first member adapted to be placed on an interior portion of the respective post office box, a flap member rotatably attached to the first member, and a sensor comprised in at least one of the first member or the flap member, as described above. Moreover, as also discussed above, when the apparatus is installed inside the respective post office box, and when the flap member is moved to be proximate to the first member to allow placement of content inside the respective post office box, the sensor is configured to detect proximity of the flap member to the first member, and provide an indication in response to detection of proximity, wherein the indication is useable to notify a recipient associated with the respective post office box. The controller, wirelessly coupled to each of the apparatuses, is coupled to a network, and configured to receive the indication from the sensor of a respective apparatus of the plurality of apparatuses, and send a notification of the content over the network to the recipient associated with the respective post office box in which the respective apparatus is installed. Thus, each apparatus may be configured for wireless communication with the controller 402. The controller may be configured to generate or retrieve the notification, e.g., from a database or other repository) based on the received indication from the sensor.

As also described above, in some embodiments, the flap member may maintain a first position when there is no content in the PO box, and may maintain a second position (i.e., a position different from the first position) when there is content in the PO box, as shown in FIG. 4 (and FIGS. 3A and 3B). In other words, when the apparatus is placed or installed inside the PO box, and when the flap member changes position to allow placement of content inside the post office box, the sensor is configured to detect the change in position of the flap member, and provide an indication in response to the detected change in position, where the indication is useable to notify a recipient associated with the post office box. In an alternative embodiment, where the content, e.g., a letter, is not kept upright to hold the flap member up (in the second position), the sensor may be configured to detect movement rather than position, and so may generate an indication any time the flap member is moved, e.g., anytime mail (or other content) is inserted (or removed) from the rear (employee side) of the PO box.

The controller 402 may be coupled to a network 403, e.g., a local area network (LAN), or a wide area network (WAN), such as the Internet, thereby providing communicative access to a plurality of client systems 410 (A, B, and C), each associated with a PO box. In one embodiment, to provide an indication, the sensor may be configured to send the indication to a controller via wireless means, e.g., via Bluetooth, WiFi, etc. The controller, coupled to network 403, may be configured to receive the indication from the sensor, and send a notification over the network to a recipient associated with the post office box, e.g., to a corresponding client system. The notification may be of any type desired, including, for example, one or more of an email message, an instant messaging (IM) message, a cellular telephone text message, or a social networking site message, among others. The controller may also include additional information in the notification, such as the user's name, time of delivery, and so forth, as desired. The controller may store various software programs and data for maintaining associations between the apparatuses/PO boxes and users (or user accounts), logging mail and notification activity, billing accounts, etc., as desired. For example, user's may pay a subscription fee for use of the apparatuses, i.e., for the notification service, and the controller may operate to track the user accounts, and even send notifications regarding payment to users as needed.

Thus, the controller may be configured to initialize the system, establishing associations between users (or user accounts) and respective mail notification apparatuses (as described herein), and may periodically (or as needed) update these associations. For example, in one embodiment, if a user switches PO boxes, an operator may provide input to the controller reassigning the user to a different apparatus (which is presumably installed in the new PO box) and cancelling the previous association. Alternatively, in embodiments where the apparatus is removably attached to the PO box, the operator may simply move the apparatus from the original PO box to the new PO box, and provide input to the controller associating the apparatus with the new PO box (and disassociating the apparatus from the old PO box).

Note that the client systems may each be of any type desired, including for example, desktop computers or workstations, laptops, pagers, or mobile computing devices, such as cell phones, smart phones, personal digital assistants (PDAs), pad computers, and so forth.

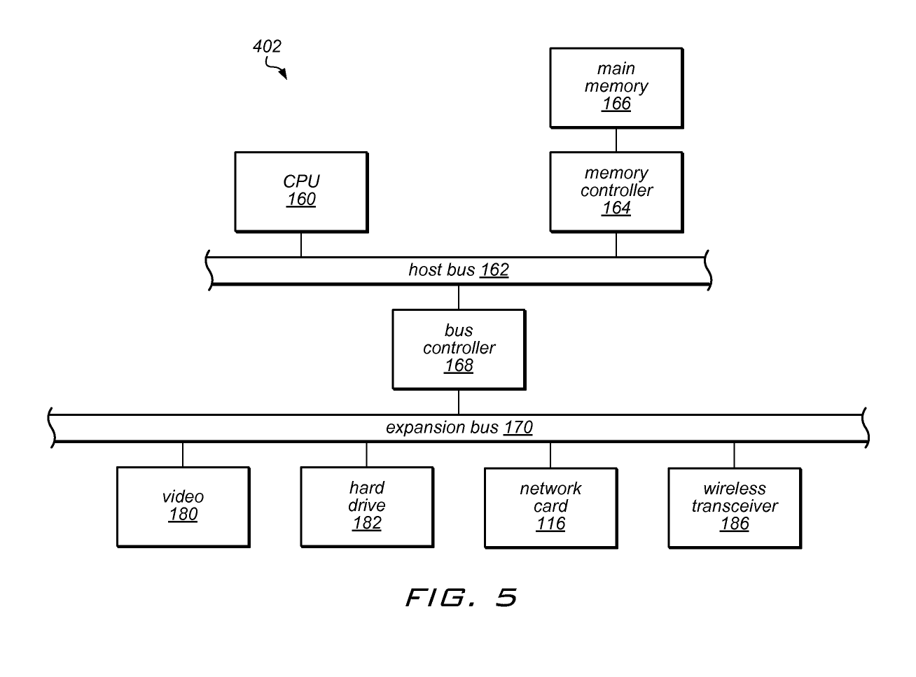

FIG. 5 is a block diagram representing one embodiment of the controller 402. It is noted that any type of computer system configuration or architecture can be used as desired, and FIG. 5 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an ×86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store program instructions implementing embodiments of the controller functionality described herein.

The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices. The computer 82 may further comprise a video display subsystem 180 and hard drive 182 coupled to the expansion bus 170. The computer 82 may also include a network card 122 for coupling to network 403, and may also include a wireless receiver 186 for communicating with the various apparatuses installed in the system.

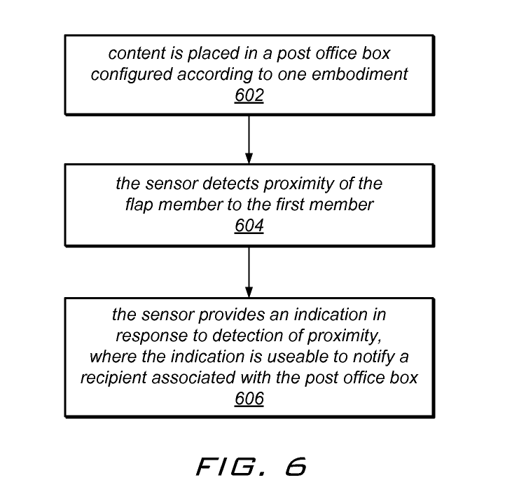

FIG. 6 is a flowchart that illustrates a method of automatically generating electronic notifications in response to received mail, according to one embodiment. The method shown in FIG. 6 may be used in conjunction with any of the computer systems or devices described herein or illustrated in the Figures, among other devices. In various embodiments, some of the method elements shown may be performed concurrently, in a different order than shown, or may be omitted. Additional method elements may also be performed as desired. As shown, this method may operate as follows.

In 602, content may be placed in a post office box configured according to one embodiment, as described above with reference to FIGS. 2-4. As also described above, the content may be one or more mail items, and/or one or more proxy cards associated with one or more mail items.

In 604, the sensor may detect proximity of the flap member to the first member. As described above, the detection may be with respect to a change in position (including orientation) of the flap member, e.g., from the first position to the second position, and may be via any of various types of sensor. Alternatively, in 604 the method may detect movement of the flap member.

In 606, the sensor may provide an indication in response to detection of proximity (or movement), where the indication is useable to notify a recipient associated with the post office box, as described above.

Thus, for example, in one exemplary embodiment, the sensor may send the indication to the controller via wireless means, where the indication possibly includes the type of mail. In some passive embodiments, the indication provision (and possibly the detection) may be performed in response to a chirp signal from the controller. Thus, the controller may periodically (or even randomly) query the PO boxes (e.g., the sensors) to retrieve or invoke transmission of the indications. In contrast, in some active embodiments, the sensors may send the indication to the controller when content is first inserted into the PO box, or periodically (or randomly).

Thus, various embodiments of the above systems and methods may provide for automatic detection and notification of content in PO boxes.

Although the embodiments above have been described in considerable detail, numerous variations and modifications will become apparent to those skilled in the art once the above disclosure is fully appreciated. It is intended that the following claims be interpreted to embrace all such variations and modifications. Other embodiments may include various modifications and alterations that still fall within the scope of the contemplated embodiments. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to. As used herein, the singular forms “a”, “an” and “the” include plural referents unless the content clearly indicates otherwise. Thus, for example, reference to “a device” includes a combination of two or more devices.

What is claimed is:

1. An apparatus for use in notifying a person of received content in a post office box, wherein the apparatus comprises:
a first member adapted to be placed on an interior portion of the post office box;
a flap member rotatably attached to the first member;
a sensor comprised in at least one of the first member or the flap member;
wherein when the apparatus is placed inside the post office box, and when the flap member is moved to be proximate to the first member to allow placement of content inside the post office box, the sensor is configured to:
detect proximity of the flap member to the first member; and
provide an indication in response to detection of proximity, wherein the indication is useable to notify a recipient associated with the post office box.

2. The apparatus of claim 1, wherein the first member is removeably attachable to the interior surface of the post office box.

3. The apparatus of claim 1, wherein the sensor is a passive sensor.

4. The apparatus of claim 1, further comprising:
a replaceable battery, configured to provide power to the apparatus.

5. The apparatus of claim 4, wherein the sensor is an active sensor, wherein the replaceable battery is configured to power the active sensor.

6. The apparatus of claim 1, further comprising an identifier (ID) that uniquely identifies the apparatus, comprising:
a human readable representation of the ID; and
a machine readable representation of the ID.

7. The apparatus of claim 6, wherein the machine readable representation of the ID comprises a radio frequency identification (RFID) tag configured to wirelessly transmit the ID to a controller in response to a chirp signal.

8. The apparatus of claim 7, wherein the sensor comprises an active sensor, the system further comprising:
a battery, coupled to the sensor, wherein the battery provides power to the sensor, and wherein the sensor is configured to actively transmit the ID, the indication, or both, to a controller via wireless means.

9. The apparatus of claim 7, further comprising:
a transmitter; and
a battery, coupled to the transmitter, wherein the battery is configured to provide power to the transmitter;
wherein the transmitter is configured to actively transmit the ID, the indication, or both, to a controller via wireless means.

10. The apparatus of claim 1, wherein the content of the post office box comprises at least one proxy card in the post office box, wherein the at least one proxy card indicates one or more of:
mail that has been delivered but is not in the post office box; or
mail that is in the post office box.

11. The apparatus of claim 10, wherein the at least one proxy card indicates type of the mail, and wherein the sensor is configured to query the proxy card and include the type of mail in the indication.

12. The apparatus of claim 1, wherein the sensor comprises one or more of:
a tilt sensor;
an orientation sensor;
a motion sensor;
a light sensor;
a weight sensor;
a Hall effect sensor;
an induction sensor;
a reed switch; or
an electrical contact sensor. NOTE: Brett, please add more if you think of any . . .

13. The apparatus of claim 1, wherein to provide an indication, the sensor is configured to:
send the indication to a controller via wireless means;
wherein the controller is coupled to a network, and wherein the controller is configured to:
receive the indication from the sensor; and
send a notification over the network to a recipient associated with the post office box.

14. The apparatus of claim 13, wherein the notification comprises one or more of:
an email message;
an instant messaging (IM) message;
a cellular telephone text message; or
a social networking site message.

15. The apparatus of claim 1, wherein the flap member is configured to:
maintain a first position when the post office box has no content; and
maintain a second position when the post office box has content;
wherein to detect movement of the flap member proximate to the first member, the sensor is configured to distinguish between the first and second positions, thereby detecting whether or not the post office box has content; and
wherein the sensor is configured to provide the indication in response to detection of the flap member in the second position.

16. The apparatus of claim 15, wherein the flap member comprises a bottom edge configured to hold the content in place when the flap member is in the second position.

17. The apparatus of claim 1, wherein the sensor is comprised in the first member.

18. The apparatus of claim 1, wherein the sensor is comprised in the flap member.

19. The apparatus of claim 1, wherein the sensor comprises:
a first sensor component comprised in the first member; and
a second sensor component comprised in the flap member.

20. An apparatus for use in notifying a person of received content in a post office box, wherein the apparatus comprises:
a first member, attachable to an interior surface of the post office box;
a flap member, rotatably attached to the first member, wherein the flap member is configured to:
maintain a first position when the post office box has no contents; and
maintain a second position when the post office box has contents; and
a sensor comprised in at least one of the first member or the flap member, wherein the sensor is configured to:
distinguish between the first and second positions, thereby detecting whether or not the post office box has content;
in response to detecting that the post office box has content, provide an indication of the content, wherein the indication of the content is useable to notify a recipient associated with the post office box of the content.

21. The apparatus of claim 20, wherein to provide an indication of the content, the sensor is configured to:
send the indication of the content to a controller via wireless means;
wherein the controller is coupled to a network, and wherein the controller is configured to:
receive the indication from the sensor; and
send a notification of the content over the network to a recipient associated with the post office box.

22. The apparatus of claim 21, wherein the notification comprises one or more of:
an email message;
an instant messaging (IM) message;
a cellular telephone text message; or
a social networking site message.

23. A system for notifying persons of received content in post office boxes, comprising:
a plurality of apparatuses, each of the apparatuses installed in a respective post office box, and each of the apparatuses respectively comprising:
a first member adapted to be placed on an interior portion of the respective post office box;
a flap member rotatably attached to the first member;
a sensor comprised in at least one of the first member or the flap member;
wherein when the apparatus is installed inside the respective post office box, and when the flap member is moved to be proximate to the first member to allow placement of content inside the respective post office box, the sensor is configured to:
detect proximity of the flap member to the first member; and
provide an indication in response to detection of proximity, wherein the indication is useable to notify a recipient associated with the respective post office box; and
a controller, wirelessly coupled to each of the apparatuses, wherein the controller is coupled to a network, and wherein the controller is configured to:
receive the indication from the sensor of a respective apparatus of the plurality of apparatuses; and
send a notification of the content over the network to the recipient associated with the respective post office box in which the respective apparatus is installed.

24. A system for notifying persons of received content in post office boxes, comprising:
a plurality of apparatuses, each of the apparatuses installed in a respective post office box, and each of the apparatuses respectively comprising:
a first member, attached to an interior surface of the respective post office box, wherein the first member comprises the first sensor component;
a flap member, rotatably attached to the first member, wherein the flap member is configured to:
maintain a first position when the respective post office box has no contents; and
maintain a second position when the respective post office box has contents; and
a sensor comprised in at least one of the first member or the flap member, wherein the sensor is configured to:
distinguish between the first and second positions, thereby detecting whether or not the respective post office box has content;
in response to detecting that the respective post office box has content, provide an indication of the content, wherein the indication of the content is useable to notify a recipient associated with the respective post office box of the content; and
a controller, wirelessly coupled to each of the apparatuses, wherein the controller is coupled to a network, and wherein the controller is configured to:
receive the indication from the sensor of a respective apparatus of the plurality of apparatuses; and
send a notification of the content over the network to the recipient associated with the respective post office box in which the respective apparatus is installed.

25. A method, comprising:
placing content in a post office box, wherein the post office box comprises:
a first member placed on an interior portion of the post office box;
a flap member rotatably attached to the first member; and
a sensor comprised in at least one of the first member or the flap member;
the flap member moving to be proximate to the first member in response to placement of content inside the post office box;
detecting, via the sensor, proximity of the flap member to the first member; and
providing, via the sensor, an indication in response to detection of proximity, wherein the indication is useable to notify a recipient associated with the post office box.

26. An apparatus for use in notifying a person of received content in a post office box, wherein the apparatus comprises:
a first member adapted to be placed on an interior portion of the post office box;
a flap member rotatably attached to the first member;
a sensor comprised in at least one of the first member or the flap member;
wherein when the apparatus is placed inside the post office box, and when the flap member changes position to allow placement of content inside the post office box, the sensor is configured to:
detect the change in position of the flap member; and
provide an indication in response to the detected change in position, wherein the indication is useable to notify a recipient associated with the post office box.
